(19) United States
(12) Patent Application Publication
(10) Pub. No.: US 2010/0299677 A1
(43) Pub. Date: Nov. 25, 2010

(54) Article of manufacture for programmatically describing web service-driven applications

(75) Inventor: Todd W. Wolff, Boerne, TX (US)

Correspondence Address: Bluestem Software LLC;Todd W. Wolff, Suite 114-608, 215 W. Bandera Road, Boerne, TX, 78006, US

(73) Assignee: Bluestem Software LLC, Boerne, TX (US)

(21) Appl. No.: 12/800,729

(22) Filed: May 21, 2010

Related U.S. Application Data
(60) Provisional application No. 61/180,831, filed on May 22, 2009.

(51) Int. Cl. G06F 9/46; G06F 9/44; G06F 13/00

(52) U.S. Cl. 719/315

(57) ABSTRACT

To programmatically describe the abstract behavior of a web-service driven application (WSDA), a class which is used to model an Interface Definition Language (IDL) extension component is provided. Nested within the modeled IDL extension component are subcomponents, each of which references an IDL component which describes a set of operations and message types exposed by the WSDA. To programmatically describe the concrete behavior of the WSDA, a class which is used to model an additional IDL extension component is provided. The additional IDL extension component describes an executable instance of the WSDA and is associated with the IDL extension component that programmatically describes the abstract behavior of the WSDA. Nested within the IDL extension component that describes the executable instance of the WSDA are subcomponents, each of which references an IDL component that describes an executable web service exposed by the WSDA.

### CROSS-REFERENCE TO RELATED APPLICATIONS

This application claims priority based on Provisional Patent Application No. 61/180,831, filed on May 22, 2009, the entire disclosure of which is incorporated herein by reference.

### BACKGROUND OF THE INVENTION

The invention relates to distributed systems within a web service-based computing environment. More specifically it relates to a method for describing/modeling web service-based applications within a distributed computing environment.

To aid in the understanding of prior art and its associated problems, it may help to provide a brief overview of distributed computing environments and the evolution of supporting technologies. A distributed computing environment consists of two or more computers connected by a network which allows the applications installed on those computers to communicate and exchange data. An application is essentially a software-based system which, from the client's point of view, provides a unified set of functionality, e.g. an accounting application, a warehouse management application, a database application, etc. . . . The network across which the applications communicate can be private or it can be public—as would be the case with the internet.

Distributed systems exist because applications are forced to run in physically separate locations. They run in separate locations because they are either hosted by different organizations or because it allows for distribution of the workload across computing resources, e.g. servers. In any case, the primary difficulty presented by a distributed computing environment relates to the fact that applications are authored by different vendors, using different programming languages and are designed to run on an array of different operating systems. Over the years, there have been many architectural approaches and supporting technologies developed to specifically address these complexities.

The first distributed computing technology to gain widespread use was the remote procedure call or RPC. RPC is an inter-process communication technology that allows a computer program to execute a procedure in another address space without the programmer explicitly coding the details for the remote interaction, i.e. the required programming is essentially the same regardless of whether the invoked procedure is local to the executing program, or remote. RPC was primarily designed for client-server based architectures, i.e. architectures which placed the majority of an application's logic on the client and shared resources such as database and file based resources on the server. Eventually, however, client-server gave way to N-Tier based architectures which separated the application logic into three or more logically and physically separate partitions and which supported the concept of object oriented design and modular programming.

There were several technologies which were designed to support distributed, object-based systems including the Common Request Broker Architecture (CORBA), the Distributed Component Object Model (DCOM) and the Remote Method Invocation (RMI) framework. All of these technologies, however, required that the applications which utilized them be programmed using specific application programming interfaces (APIs) and be coded using a specific programming language, e.g. Java and C++. These technologies also created very “tightly coupled” systems, i.e. the message passing between applications were synchronous and required that the caller block for a response before it could continue processing its work. Consequently, performance issues experienced by one application could potentially degrade the performance of other dependent applications.

It was around this time that the internet and its use as a medium for business related transactions began to rise in popularity and companies began developing multi-tier, web-based applications. Again, the applications which were coded using a variety of different programming languages and were deployed on a variety of different computing platforms. Various web-based standards and technologies were developed to support application level integration within this type of environment—the most prevalent of which was “web services.” According to the W3C, an international standards organization, a web service is “a software system designed to support interoperable machine-to-machine interaction over a network.” Web services are platform agnostic and can be invoked by clients using an open set of standardized message-based protocols including the Simple Object Access Protocol (SOAP) and the Representational State Transfer (REST) protocol. The current best practice in regards to designing systems which require integration at the application layer, and one which embraces the concept of web-based services, is service-oriented architecture or SOA.

SOA is not a standard, but instead represents a general approach to systems architecture. SOA implicitly incorporates various web based standards (WS-*) and promotes designing and developing systems which are based around a loosely coupled set of web services. Services which participate within a SOA describe the messages, operations and various protocols which are required to invoke them within a machine-readable “description” document. At present, there are two Interface Definition Languages (IDLs) which are used to describe web services—the Web Service Description Language (WSDL) and the Web Application Description Language (WADL.) WADL, which is better suited for describing REST based services, is not widely supported at present and will not be described here. WSDL, on the other hand, can be used to describe both SOAP and REST based web services and is widely implemented within the industry.

The most recent version of WSDL is version 2.0 and represents a significant improvement over the prior version, version 1.1. The discussion that follows is based upon version 2.0 of the standard. The WSDL specification utilizes a component-based approach to describing web services. FIG. 1 represents a graphical depiction of a WSDL document (100). As shown in FIG. 1, the various component types defined by the WSDL specification are categorized as being either abstract (105) or concrete (150). An abstract component, as its name implies, models an abstraction of a specific type of behavior, while a concrete component provides an implementation of that behavior. Using the WSDL component model, lower level components can be aggregated into progressively higher level components. The WSDL component model defines an XML based serialization for each component type, i.e. a language specific approach to reading and writing each component. An XML document can be programmatically “consumed” by a program and translated into “classes” (in object-oriented programming, a class is a construct which serves as a blueprint or template which can be used to create objects or instances of that class) which can be used by the program to programmatically manipulate the components and ultimately host and/or invoke the described service. The name and specific functionality of each WSDL component is as follows:
Types: The types section (110) of a WSDL document, defines the abstract XML data types which serve as payloads, i.e. message payloads which are consumed and generated by the described service. The specification leverages an open set of standards which can be used to describe the data types, the most common of which is XML Schema (115). The schema document can either be embedded (not shown) or it can be imported, as represented in the following example:

### Example 1

```
<wsdl:description xmlns:wsdl=“http://www.w3.org/ns/wsdl”
        targetNamespace=“http://software.vendor.com/1.0”
        xmlns:tns=“http://software.vendor.com/1.0”>
  <wsdl:types>
  <xs:import namespace=“http://mycompany.com/business/docs”
      xmlns:xs=“http://www.w3.org/2001/XMLSchema” />
  </wsdl:types>
</wsdl:description>
```

Interface: A WSDL Interface component (120) is an abstract component which defines the set of operations and associated messages which are implemented by the described service. Each Interface component (120) can define one or more operations (125). Each operation defines an input message (130), an optional output message (135) and one or more optional fault messages (not shown) and each message references a type defined within the WSDL types section (110) as represented within the following example:

### Example 2

```
<wsdl:description xmlns:wsdl=“http://www.w3.org/ns/wsdl”
      targetNamespace=“http://software.vendor.com/1.0”
      xmlns:tns=“http://software.vendor.com/1.0”>
  <wsdl:interface name=“AvailabilityProcessor”
      xmlns:ns01=“http://mycompany.com/business/docs”>
  <wsdl:fault name=“OutOfStockFault” element=
  “ns01:OutOfStockFault” />
  <wsdl:operation name=“checkAvailability”
        pattern=“http://www.w3.org/ns/wsdl/in-out”>
    <wsdl:input element=“ns01:AvailabilityRequest”
      xmlns:wsam=“http://www.w3.org/2007/05/addressing/metadata”
      wsam:Action=“urn:checkAvailability” />
    <wsdl:output element=“ns01:AvailabilityResponse”
        xmlns:wsam=“http://www.w3.org/2007/05/addressing/metadata”
        wsam:Action=“urn:checkAvailabilityResponse” />
  </wsdl:operation>
  </wsdl:interface>
  <wsdl:interface name=“OrderProcessor”
      xmlns:ns01=“http://mycompony.com/business/docs”>
  <wsdl:operation name=“scheduleOrder” pattern=“http://www.w3.org/
  ns/wsdl/in-out”>
    <wsdl:input element=“ns01:ScheduleOrderRequest”
      xmlns:wsam=“http://www.w3.org/2007/05/addressing/metadata”
      wsam:Action=“urn:scheduleOrder” />
    <wsdl:output element=“ns01:ScheduleOrderResponse”
        xmlns:wsam=“http://www.w3.org/2007/05/addressing/metadata”
        wsam:Action=“urn:scheduleOrderResponse” />
  </wsdl:operation>
  <wsdl:operation name=“getOrderStatus”
        pattern=“http://www.w3.org/ns/wsdl/in-out”
        style=“http://www.w3.org/ns/wsdl/style/iri”
        xmlns:wsdlx=“http://www.w3.org/ns/wsdl-extensions”>
    <wsdl:input element=“ns01:getOrderStatus”
      xmlns:wsam=“http://www.w3.org/2007/05/addressing/metadata”
      wsam:Action=“urn:getOrderStatus” />
    <wsdl:output element=“ns01:OrderStatusResponse”
        xmlns:wsam=“http://www.w3.org/2007/05/addressing/metadata”
        wsam:Action=“urn:getOrderStatusResponse” />
  </wsdl:operation>
  </wsdl:interface>
</wsdl:description>
```

Binding: A WSDL Binding component (155) is a concrete component. A Binding component “binds” various protocol specific semantics to the abstract Interface component (120) implemented by the described service. The Binding component (155) specifies, at a minimum, the transmission protocol, e.g. HTTP, and the messaging protocol, e.g. SOAP, as represented within the following example:

### Example 3

```
<wsdl:description xmlns:wsdl=“http://www.w3.org/ns/wsdl”
        targetNamespace=“http://my.company.com/wm/atlanta/1.0”
        xmlns:tns=“http://my.company.com/wm/atlanta/1.0”
        xmlns:ns01=“http://software.vendor.com/1.0”>
  <wsdl:binding name=“SOAP12Binding”
      type=“http://www.w3.org/ns/wsdl/soap”
      xmlns:wsoap=“http://www.w3.org/ns/wsdl/soap”
      wsoap:version=“1.2”
      wsoap:protocol=“http://www.w3.org/2003/05/soap/bindings/
      HTTP/” />
</wsdl:description>
```

Service: A WSDL Service component (160) is a concrete component which describes an executable web service. The Service component (160) defines one or more Endpoints (165) each of which identifies an address which can be used by clients to invoke the service. Each endpoint references a Binding component (155) which defines the runtime protocols required by that endpoint. As discussed above, a Service component (160) implements an Interface component (120), which defines the abstract requirements of that service, i.e. the required operations and associated message types, all of which can be declared as represented in the following example:

### Example 4

```
<wsdl:description xmlns:wsdl=“http://www.w3.org/ns/wsdl”
      targetNamespace=“http://my.company.com/wm/atlanta/1.0”
      xmlns:tns=“http://my.company.com/wm/atlanta/1.0”
      xmlns:ns01=“http://software.vendor.com/1.0”>
  <wsdl:service name=“AvailabilityService” interface=
  “ns01:AvailabilityProcessor”>
  <wsdl:endpoint name=“SOAP12Endpoint”
        binding=“tns:SOAP12Binding”
        xmlns:whtp=“http://www.w3.org/ns/wsdl/http”
        whtp:authenticationScheme=“basic”
        whtp:authenticationRealm=“warehouse”
        address=“http://localhost:8082/eoa/ws/AvailabilityService/
        SOAP12Endpoint/”>
  </wsdl:endpoint>
  </wsdl:service>
  <wsdl:service name=“OrderService” interface=“ns01:OrderProcessor”>
  <wsdl:endpoint name=“SOAP12Endpoint”
        binding=“tns:SOAP12Binding”
        xmlns:whtp=“http://www.w3.org/ns/wsdl/http”
        whtp:authenticationScheme=“basic”
        whtp:authenticationRealm=“warehouse”
        address=“http://localhost:8082/eoa/ws/OrderService/
        SOAP12Endpoint/”>
  </wsdl:endpoint>
  </wsdl:service>
</wsdl:description>
```

While the current state-of-the-art represents a big improvement in terms of modeling distributed systems, if fails to address a critical aspect of the applications it describes, i.e. most applications define functionality which would be difficult to express as a single web service. Most applications instead define multiple services, each of which encapsulates a subset of the application's overall functionality. Using a hypothetical warehouse management application as an example, its functionality might be exposed via three web services, e.g. a service which checks the availability of inventory items required to fulfill a customer order (see the “AvailabilityService” modeled in Example 4) and a service which schedules the customer order and provides updates on its fulfillment status (see the “OrderService” modeled in Example 4) and a service which manages the receipt and shipment of inventory items (not shown). The current state-of-the-art provides no means by which a service-oriented architect can model and logically group these three services into a single, unified object, which can then be deployed and programmatically manipulated.

### BRIEF SUMMARY OF THE INVENTION

In accordance with certain aspects of the invention, logic stored on a medium, e.g. software, is configured to be read and executed by one or more processors, e.g. one or more computers, so as to cause the processor(s) to programmatically model the abstract behavior of a web-service driven application (WSDA). To do so, the processor(s) provides, responsive to a user input, a class which is used to model an Interface Definition Language (IDL) extension component. The modeled extension component is a component that defines the abstract behavior of the WSDA. The processor(s) also provides, responsive to same input, either the same class or a different class which is used to model a subcomponent. One or more of the modeled subcomponents is nested within the extension component and each subcomponent is associated with a different, preexisting IDL component (X) that defines a set of operations and corresponding message types exposed by the WSDA.

The IDL may, for example, be Web Service Description Language (WSDL). If WSDL, the user input is a WSDL document. If WSDL, the preexisting IDL component X is preferably what is commonly referred to as an Interface component. The MI extension component is preferably what is commonly referred to as an Application component and the set of nested subcomponents is preferably what are commonly referred to as Role components.

According to other aspects of the invention, logic stored on a medium is configured to cause the processor(s) to programmatically model the concrete behavior of a WSDA by providing, responsive to a user input, a class which is used to model an Interface Definition Language (IDL) extension component. The modeled extension component is a component that defines the concrete behavior of the WSDA and is associated with a preexisting IDL extension component that defines the abstract behavior of the WSDA (e.g. the earlier described IDL extension component).

The processor(s) additionally provide, responsive to same input, either the same class or a different class which is used to model a subcomponent. One or more of the modeled subcomponents is nested within the IDL extension component and each subcomponent is associated with a different, preexisting IDL component (Y) that describes an executable web service exposed by the WSDA.

Here again, the IDL may, for example, be Web Service WSDL. If WSDL, the user input is a WSDL document. If WSDL, the preexisting IDL component Y is preferably what is commonly referred to as a Service component and the preexisting IDL component X is preferably what is commonly referred to as an Interface component. The IDL extension component is preferably what is commonly referred to as an Engine component and the set of nested subcomponents is preferably what are commonly referred to as Actor components.

### BRIEF DESCRIPTION OF THE SEVERAL VIEWS OF THE DRAWINGS

FIG. 1: depicts conventional components as defined by the current state-of-the-art.

FIG. 2: depicts additional components in accordance with the present invention.

### DETAILED DESCRIPTION OF THE INVENTION

The preferred embodiment of the invention is a component based framework which defines the components that are missing from the current state-of-the-art and which facilitates the modeling of web service-driven applications (WSDA) such that they can be described, deployed and programmatically manipulated as a single object. Additionally, the preferred embodiment of the invention defines an extensible markup language (XML) based serialization which can be used to read and write each defined component type. The resulting XML document can be “consumed” by a program and translated into “classes” (in object-oriented programming, a class is a construct which serves as a blueprint or template which can be used to create objects or instances of that class) which can then be used by the program to programmatically manipulate the components and ultimately host and/or invoke the described WSDA. Note that while the preferred embodiment defines an XML based serialization, other serializations could be used, e.g. javascript object notation (JSON,) etc. . . .

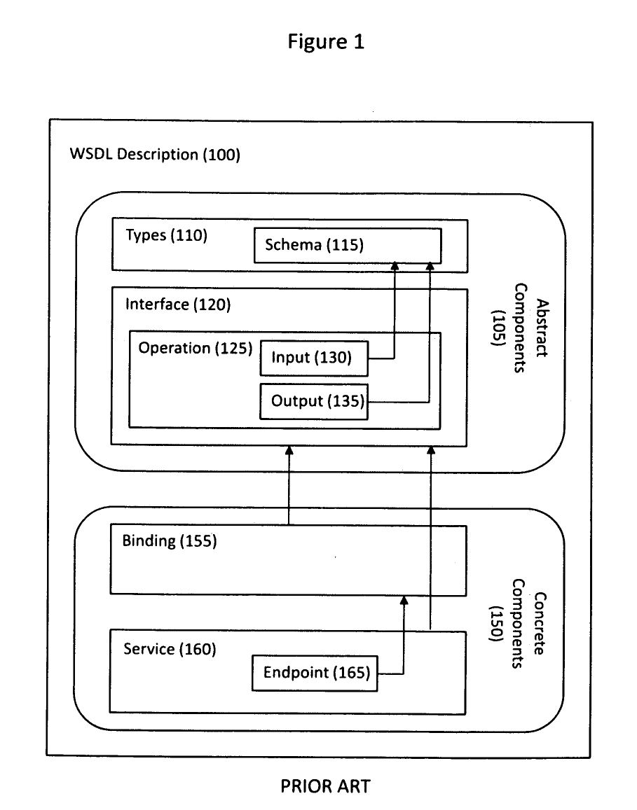

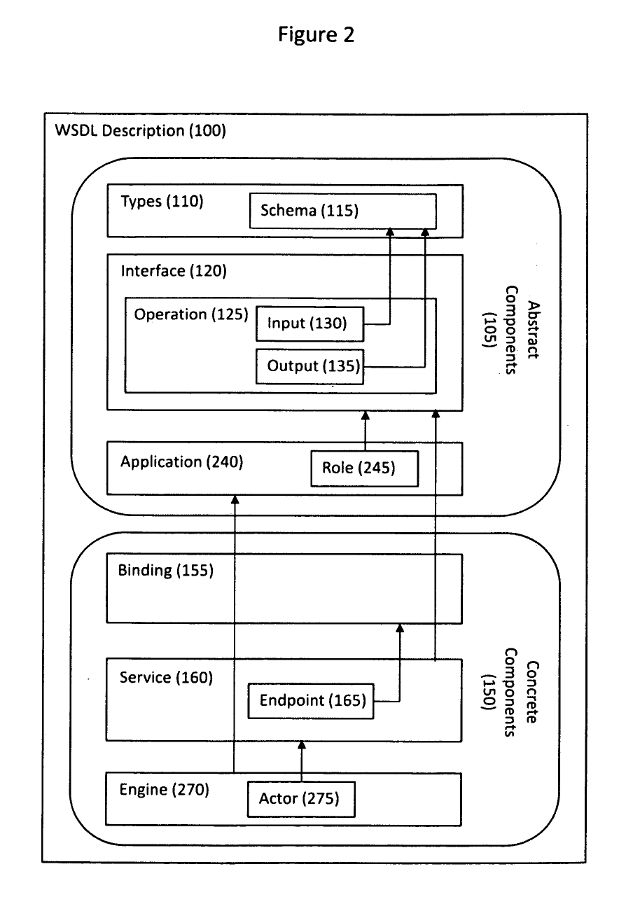

The components defined by the invention complement, or extend, rather than replace the component frameworks of existing IDLs and as such are referred to as “extension” components within the description that follows. The examples below are defined as extensions to the WSDL 2.0 component model, but other IDL component models could be used as well, e.g. WSDL 1.1, WADL, etc. . . . As depicted within FIG. 2, the invention defines two new components (240) and (270), which are missing from the current state-of-the-art, one of which is abstract, and the other of which is concrete. Note that in FIG. 2, components corresponding to those described above with reference to FIG. 1, are identified with like reference numerals. The new abstract component is known within the preferred embodiment as the Application component (240). The preferred embodiment defines a WSDL extension element, i.e. the <wsdl:application> element, which is used to declare the Application component (240), as represented within the following XML based serialization:

### Example 5

```
<deployment xmlns=“http://bluestemsoftware.org/specification/eoa/1.0/
deployment”>
  <components>
  <wsdl:description xmlns:wsdl=“http://www.w3.org/ns/wsdl”
          targetNamespace=“http://software.vendor.com/1.0”
          xmlns:tns=“http://software.vendor.com/1.0”>
    <ext:application
        xmlns:ext=“http://bluestemsoftware.org/specification/eoa/1.0/
        component/wsdl/ext”
          name=“WarehouseManager”>
    <ext:role name=“http://mycompany.com/wm/availability/processor”
        interface=“tns:AvailabilityProcessor” />
    <ext:role name=“http://mycompany.com/wm/order/processor”
        interface=“tns:OrderProcessor” />
    </ext:application>
  </wsdl:description>
  </components>
</deployment>
```

The example Application component declared above, references the example Interface component declarations declared in Example 2, namely the “AvailabilityProcessor” component and the “OrderProcessor” component. The Application component (240) groups a related set of Interface components into a single unit. The Interface components (120) are referenced by Role components (245) which are nested within the Application component (240). Each Role component (245) defines a specific “role” which is performed by the described application. The set of roles, when taken as a whole, represent an abstract description of an application's functionality, i.e. it defines an application's behavior from the client's perspective. Note that while the WSDL extension elements used to declare the Application and nested Role components use the qualified names “ext:application” and “ext:role” respectively, other embodiments of the invention could use different names.

The new concrete component is known within the preferred embodiment as the Engine component (270). The preferred embodiment defines a WSDL extension element, i.e. the <wsdl:engine> element, which is used to declare the Engine component (270) and which serves to group a related set of Service components (160) into a single, referenceable unit as depicted in the following XML based serialization:

### Example 6

```
<deployment xmlns=“http://bluestemsoftware.org/specification/eoa/1.0/
deployment”>
  <components>
  <wsdl:description xmlns:wsdl=“http://www.w3.org/ns/wsdl”
          targetNamespace=“http://my.company.com/wm/atlanta/1.0”
          xmlns:tns=“http://my.company.com/wm/atlanta/1.0”
          xmlns:ns01=“http://software.vendor.com/1.0”>
    <ext:engine
      xmlns:ext=“http://bluestemsoftware.org/specification/eoa/1.0/
      component/wsdl/ext”
      name=“WarehouseManagerEngine”
      application=“ns01:WarehouseManager”>
    <ext:actor role=“http://mycompany.com/wm/availability/processor”
        service=“tns:AvailabilityService” />
    <ext:actor role=“http://mycompany.com/wm/order/processor”
        service=“tns:OrderService” />
    </ext:engine>
  </wsdl:description>
  </components>
</deployment>
```

The sample Engine component declared in the example above, references the sample “WarehouseManager” Application component declared in Example 5. The Engine component (270) defines a set of nested Actor components (275) each of which references a Service component (160). Each referenced Service component (160) references an Interface component (120). The collective set of referenced Interface components (120) are the same set of Interface components referenced by the Application component (240) that is referenced by the Engine component (270). Note that while the WSDL extension elements used to declare the Engine and nested Actor components use the qualified names “ext:engine” and “ext:actor” respectively, other embodiments of the invention could use different names. While an Application component (240) abstractly defines an application's behavior, the Engine component (270) represents a concrete model of an actual, running application instance, i.e. one which is deployed and executed on a host computer and which can be programmatically manipulated and invoked by a client.

What is claimed is:

1. An article of manufacture for programmatically modeling the abstract behavior of a web-service driven application (WSDA), comprising:
storage media; and
logic stored on the storage media, wherein the stored logic is configured to be readable by one or more processors and thereby cause the one or more processors to operate so as to:
provide, responsive to a user input, a class which is used to model an Interface Definition Language (IDL) extension component, wherein the modeled extension component is a component that defines the abstract behavior of the WSDA;
provide, responsive to same input, either the same class, or a different class, which is used to model a subcomponent, wherein one or more of the subcomponents is nested within the extension component and each subcomponent is associated with a different, preexisting IDL component (X) that defines a set of operations and corresponding message types exposed by the WSDA.

2. The article of manufacture of claim 1, wherein:
the IDL is Web Service Description Language (WSDL);
the user input is a WSDL document;
the preexisting IDL component X is an Interface component;
the modeled IDL extension component is an Application component;
the set of subcomponents nested within the modeled IDL extension component are Role components.

3. An article of manufacture for programmatically modeling the concrete behavior of a web-service driven application (WSDA), comprising:
storage media; and
logic stored on the storage media, wherein the stored logic is configured to be readable by one or more processors and thereby cause the one or more processors to operate so as to:
provide, responsive to a user input, a class which is used to model an Interface Definition Language (IDL) extension component, wherein the modeled extension component is a component that defines the concrete behavior of the WSDA and that is associated with a preexisting IDL extension component that defines the abstract behavior of the WSDA;
provide, responsive to same input, either the same class or a different class which is used to model a subcomponent, wherein one or more of the subcomponents is nested within the extension component and each subcomponent is associated with a different, preexisting IDL component (Y) that describes an executable web service exposed by the WSDA;

4. The article of manufacture of claim 3, wherein:
the IDL is Web Service Description Language (WSDL);
the user input is a WSDL document;
the preexisting IDL component Y is a Service component;
the modeled. IDL extension component is an Engine component;
the set of subcomponents nested within the modeled IDL extension component are Actor components.
